(19) United States
(12) Patent Application Publication
(10) Pub. No.: US 2023/0136011 A1
(43) Pub. Date: May 4, 2023

(54) CONNECTED MODE SYNCHRONIZATION IN A SCALABLE CELL SYSTEM

(71) Applicant: QUALCOMM Incorporated, San Diego, CA (US)

(72) Inventors: Hung Dinh LY, San Diego, CA (US); Hwan Joon KWON, San Diego, CA (US); Krishna Kiran MUKKAVILLI, San Diego, CA (US)

(21) Appl. No.: 17/452,733

(22) Filed: Oct. 28, 2021

(51) Int. Cl. H04W 56/00; H04B 7/0426; H04L 5/00

(52) U.S. Cl. CPC H04W 56/001; H04B 7/043; H04L 5/0048

(57) ABSTRACT

Various aspects of the present disclosure generally relate to wireless communication. In some aspects, a user equipment (UE) may receive a first reference signal (RS) from a first antenna panel of a plurality of antenna panels associated with at least one transmit receive point (TRP) of a scalable cell system that includes a set of anchor TRPs associated with a cell and a set of on-demand TRPs associated with the cell, wherein the first RS is associated with a frequency and a transmission configuration indicator (TCI). The UE may receive a second RS from a second antenna panel of the plurality of antenna panels, wherein the second RS is associated with the frequency and the TCI, and wherein the at least one TRP comprises an on-demand TRP. Numerous other aspects are described.

### FIELD OF THE DISCLOSURE

Aspects of the present disclosure generally relate to wireless communication and to techniques and apparatuses for connected mode synchronization in a scalable cell system.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a first reference signal (RS) from a first antenna panel of a plurality of antenna panels associated with at least one transmit receive point (TRP) of a scalable cell system that includes a set of anchor TRPs associated with a cell and a set of on-demand TRPs associated with the cell, wherein the first RS is associated with a frequency and a transmission configuration indicator (TCI). The method may include receiving a second RS from a second antenna panel of the plurality of antenna panels, wherein the second RS is associated with the frequency and the TCI, and wherein the at least one TRP comprises an on-demand TRP.

Some aspects described herein relate to a method of wireless communication performed by a first TRP of a plurality of TRPs of a scalable cell system that includes a set of anchor TRPs associated with a cell and a set of on-demand TRPs associated with the cell. The method may include transmitting an RS configuration that indicates a first RS corresponding to a first antenna panel associated with the first TRP and associated with a frequency and a TCI, wherein the frequency and the TCI are associated with a second RS corresponding to a second antenna panel associated with the first TRP or a second TRP of the plurality of TRPs. The method may include transmitting the first RS, wherein at least one of the first TRP or the second TRP comprises an on-demand TRP.

Some aspects described herein relate to a UE for wireless communication. The user equipment may include a memory and one or more processors coupled to the memory. The one or more processors may be configured to receive a first RS from a first antenna panel of a plurality of antenna panels associated with at least one TRP of a scalable cell system that includes a set of anchor TRPs associated with a cell and a set of on-demand TRPs associated with the cell, wherein the first RS is associated with a frequency and a TCI. The one or more processors may be configured to receive a second RS from a second antenna panel of the plurality of antenna panels, wherein the second RS is associated with the frequency and the TCI, and wherein the at least one TRP comprises an on-demand TRP.

Some aspects described herein relate to a first TRP for wireless communication. The first transmission reception point may include a memory and one or more processors coupled to the memory. The one or more processors may be configured to transmit an RS configuration that indicates a first RS corresponding to a first antenna panel associated with the first TRP and associated with a frequency and a TCI, wherein the frequency and the TCI are associated with a second RS corresponding to a second antenna panel associated with the first TRP or a second TRP of the plurality of TRPs. The one or more processors may be configured to transmit the first RS, wherein at least one of the first TRP or the second TRP comprises an on-demand TRP.

Some aspects described herein relate to a non-transitory computer-readable medium that stores a set of instructions for wireless communication by a UE. The set of instructions, when executed by one or more processors of the UE, may cause the UE to receive a first RS from a first antenna panel of a plurality of antenna panels associated with at least one TRP of a scalable cell system that includes a set of anchor TRPs associated with a cell and a set of on-demand TRPs associated with the cell, wherein the first RS is associated with a frequency and a TCI. The set of instructions, when executed by one or more processors of the UE, may cause the UE to receive a second RS from a second antenna panel of the plurality of antenna panels, wherein the second RS is associated with the frequency and the TCI, and wherein the at least one TRP comprises an on-demand TRP.

Some aspects described herein relate to a non-transitory computer-readable medium that stores a set of instructions for wireless communication by a first TRP. The set of instructions, when executed by one or more processors of the TRP, may cause the TRP to transmit an RS configuration that indicates a first RS corresponding to a first antenna panel associated with the first TRP and associated with a frequency and a TCI, wherein the frequency and the TCI are associated with a second RS corresponding to a second antenna panel associated with the first TRP or a second TRP of the plurality of TRPs. The set of instructions, when executed by one or more processors of the TRP, may cause the TRP to transmit the first RS, wherein at least one of the first TRP or the second TRP comprises an on-demand TRP.

Some aspects described herein relate to an apparatus for wireless communication. The apparatus may include means for receiving a first RS from a first antenna panel of a plurality of antenna panels associated with at least one TRP of a scalable cell system that includes a set of anchor TRPs associated with a cell and a set of on-demand TRPs associated with the cell, wherein the first RS is associated with a frequency and a TCI. The apparatus may include means for receiving a second RS from a second antenna panel of the plurality of antenna panels, wherein the second RS is associated with the frequency and the TCI, and wherein the at least one TRP comprises an on-demand TRP.

Some aspects described herein relate to an apparatus for wireless communication. The apparatus may include means for transmitting an RS configuration that indicates a first RS corresponding to a first antenna panel associated with a first TRP and associated with a frequency and a TCI, wherein the frequency and the TCI are associated with a second RS corresponding to a second antenna panel associated with the first TRP or a second TRP of the plurality of TRPs. The apparatus may include means for transmitting the first RS, wherein at least one of the first TRP or the second TRP comprises an on-demand TRP.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a scalable cell system, in accordance with the present disclosure.

FIG. 4 is a diagram illustrating an example associated with connected mode synchronization in a scalable cell system, in accordance with the present disclosure.

FIGS. 5 and 6 are diagrams illustrating example processes associated with connected mode synchronization in a scalable cell system, in accordance with the present disclosure.

FIGS. 7 and 8 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

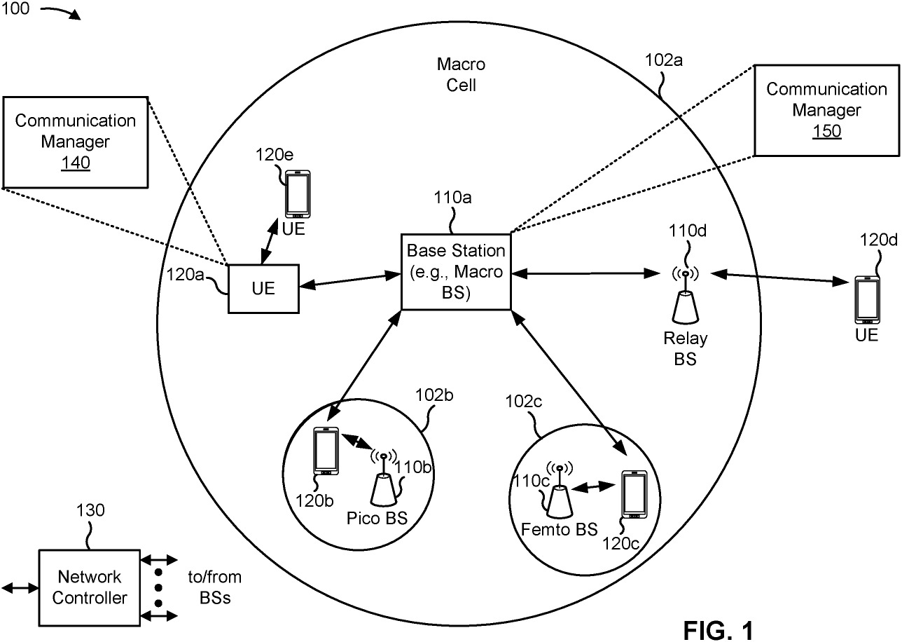

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link. For example, in some aspects, the wireless network 100 may be, include, or be included in a wireless backhaul network, sometimes referred to as an integrated access and backhaul (IAB) network. In an IAB network, at least one base station (e.g., base station 110) may be an anchor base station that communicates with a core network via a wired backhaul link, such as a fiber connection. An anchor base station may also be referred to as an IAB donor (or IAB-donor), a central entity, a central unit, and/or the like. An IAB network may include one or more non-anchor base stations, sometimes referred to as relay base stations or IAB nodes (or IAB-nodes). The non-anchor base station may communicate directly with or indirectly with (e.g., via one or more non-anchor base stations) the anchor base station via one or more backhaul links to form a backhaul path to the core network for carrying backhaul traffic. Backhaul links may be wireless links. Anchor base station(s) and/or non-anchor base station(s) may communicate with one or more UEs (e.g., UE 120) via access links, which may be wireless links for carrying access traffic.

In some aspects, a radio access network that includes an IAB network may utilize millimeter wave technology and/or directional communications (e.g., beamforming, precoding and/or the like) for communications between base stations and/or UEs (e.g., between two base stations, between two UEs, and/or between a base station and a UE). For example, wireless backhaul links between base stations may use millimeter waves to carry information and/or may be directed toward a target base station using beamforming, precoding, and/or the like. Similarly, wireless access links between a UE and a base station may use millimeter waves and/or may be directed toward a target wireless node (e.g., a UE and/or a base station). In this way, inter-link interference may be reduced.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz - 7.125 GHz) and FR2 (24.25 GHz - 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz - 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz - 71 GHz), FR4 (52.6 GHz - 114.25 GHz), and FR5 (114.25 GHz - 300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a first reference signal (RS) from a first antenna panel of a plurality of antenna panels associated with at least one transmit receive point (TRP) of a scalable cell system that includes a set of anchor TRPs associated with a cell and a set of on-demand TRPs associated with the cell, wherein the first RS is associated with a frequency and a transmission configuration indicator (TCI); and receive a second RS from a second antenna panel of the plurality of antenna panels, wherein the second RS is associated with the frequency and the TCI, and wherein the at least one TRP comprises an on-demand TRP. Additionally, or alternatively, the communication manager 140 may perform one or more other operations described herein.

In some aspects, the base station 110 may include a communication manager 150. As described in more detail elsewhere herein, the communication manager 150 may transmit an RS configuration that indicates a first RS corresponding to a first antenna panel associated with the first TRP and associated with a frequency and a TCI, wherein the frequency and the TCI are associated with a second RS corresponding to a second antenna panel associated with the first TRP or a second TRP of the plurality of TRPs; and transmit the first RS, wherein at least one of the first TRP or the second TRP comprises an on-demand TRP. Additionally, or alternatively, the communication manager 150 may perform one or more other operations described herein.

As indicated above, FIG. 1 is provided as an example. Other examples may differ from what is described with regard to FIG. 1.

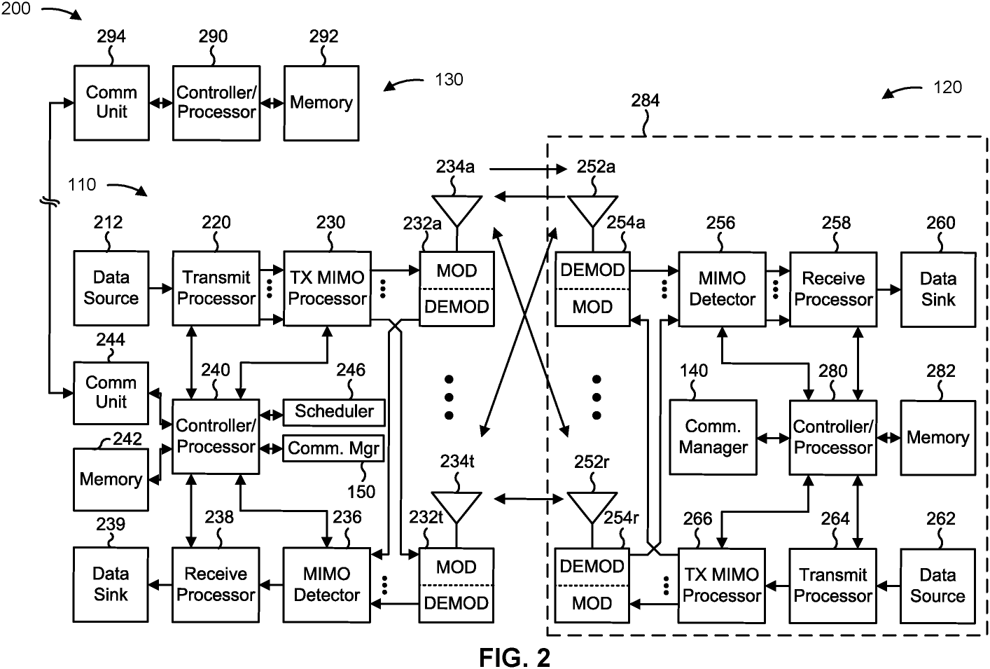

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T ≥ 1). The UE 120 may be equipped with a set of antennas 252a through 252r, such as R antennas (R ≥ 1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving RF signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications. In such a case, the base station may provide the UE with a configuration of TCI states that respectively indicate beams that may be used by the UE, such as for receiving a physical downlink shared channel (PDSCH). The base station may indicate an activated TCI state to the UE, which the UE may use to select a beam for receiving the PDSCH.

A beam indication is an indication of a beam. A beam indication may be, or include, a TCI state information element, a beam identifier (ID), spatial relation information, a TCI state ID, a close loop index, a panel ID, a TRP ID, and/or a sounding reference signal (SRS) set ID, among other examples. A TCI state information element (IE) may indicate information associated with a beam such as a downlink beam. For example, the TCI state IE may indicate a TCI state identification (e.g., a tci-StateID), a quasi-co-location (QCL) type (e.g., a qcl-Type1, qcl-Type2, qcl-TypeA, qcl-TypeB, qcl-TypeC, and/or qcl-TypeD, among other examples), a cell identification (e.g., a ServCellIndex), a bandwidth part identification (bwp-Id), and/or a reference signal identification such as a CSI-RS (e.g., an NZP-CSI-RS-Resourceld, and/or an SSE-Index, among other examples), among other examples. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, the network may support common TCI state identifier ID update and activation to provide common QCL information and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

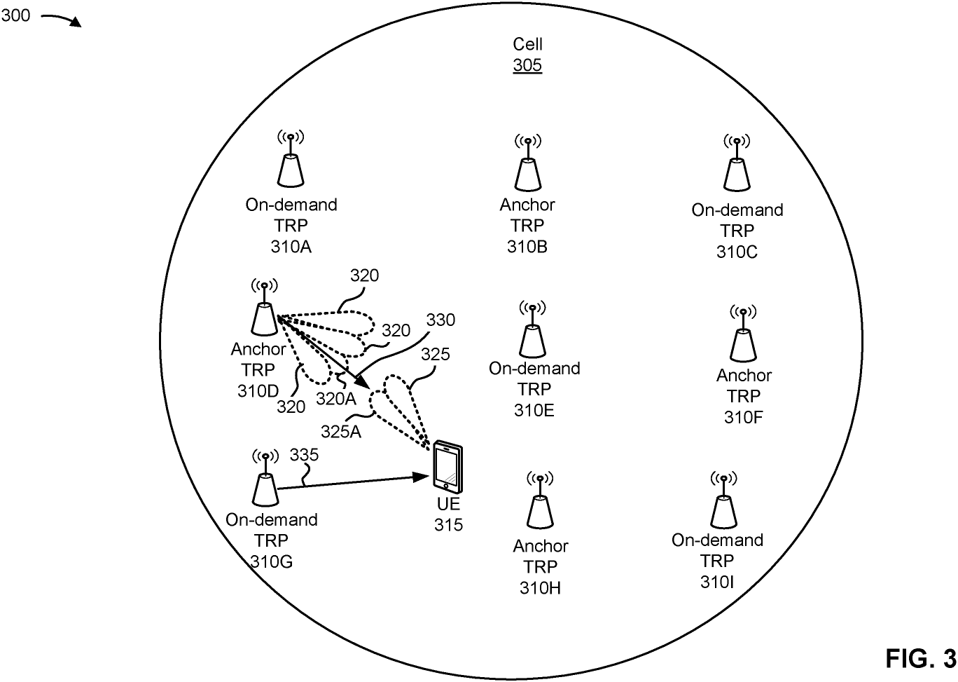

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-8).

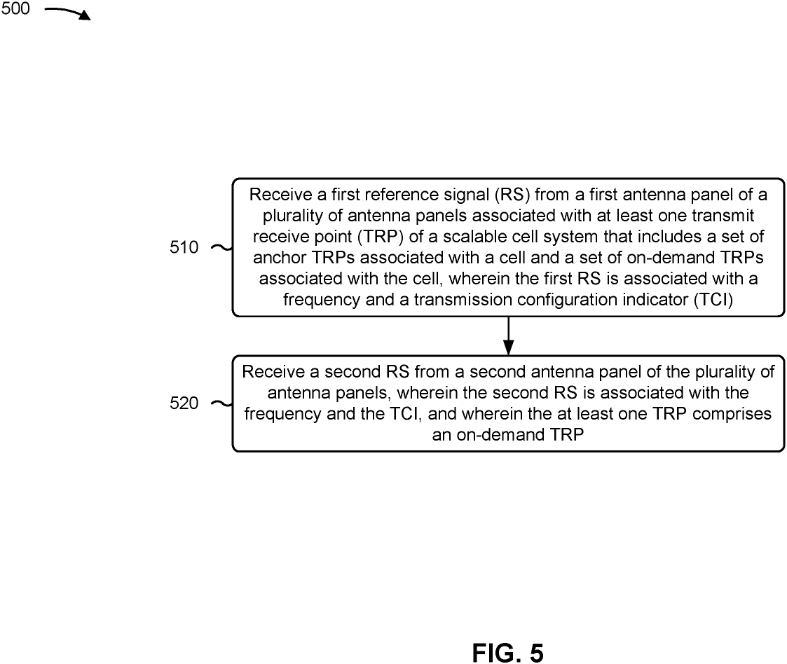

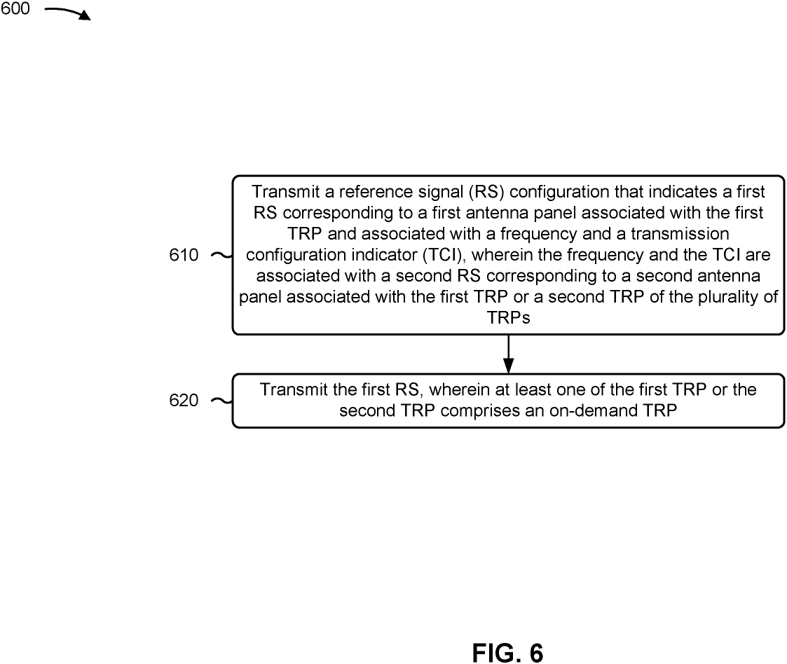

The controller/processor 240 of the base station 110, the controller/processor 280 of the UE 120, and/or any other component(s) of FIG. 2 may perform one or more techniques associated with connected mode synchronization in a scalable cell system, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. In some aspects, a TRP described herein is the base station 110, is included in the base station 110, or includes one or more components of the base station 110 shown in FIG. 2. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, the UE includes means for receiving a first RS from a first antenna panel of a plurality of antenna panels associated with at least one TRP of a scalable cell system that includes a set of anchor TRPs associated with a cell and a set of on-demand TRPs associated with the cell, wherein the first RS is associated with a frequency and a TCI (e.g., using antenna 252, modem 254, MIMO detector 256, receive processor 258, controller/processor 280, memory 282, or the like); and/or means for receiving a second RS from a second antenna panel of the plurality of antenna panels, wherein the second RS is associated with the frequency and the TCI, and wherein the at least one TRP comprises an on-demand TRP (e.g., using antenna 252, modem 254, MIMO detector 256, receive processor 258, controller/processor 280, memory 282, or the like). The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the first TRP includes means for transmitting an RS configuration that indicates a first RS corresponding to a first antenna panel associated with the first TRP and associated with a frequency and a TCI, wherein the frequency and the TCI are associated with a second RS corresponding to a second antenna panel associated with the first TRP or a second TRP of the plurality of TRPs (e.g., using controller/processor 240, transmit processor 220, TX MIMO processor 230, modem 232, antenna 234, memory 242, or the like); and/or means for transmitting the first RS, wherein at least one of the first TRP or the second TRP comprises an on-demand TRP (e.g., using controller/processor 240, transmit processor 220, TX MIMO processor 230, modem 232, antenna 234, memory 242, or the like). The means for the first TRP to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of a scalable cell system, in accordance with the present disclosure. As shown in FIG. 3, a cell 305 may include a number of transmission reception points (TRPs) 310A–310I. The TRPs may include a set of anchor TRPs 310B, 310D, 310F, and 310H, and a set of on-demand TRPs 310A, 310C, 310E, 310G, and 310I. The set of anchor TRPs is a non-zero set that includes one or more anchor TRPs and the set of on-demand TRPs is a non-zero set that includes one or more on-demand TRPs. Any number of additional (or fewer) TRPs may be implemented in associated with the cell 305.

One or more of the TRPs 310A–310I may transmit to a UE 315 located within a coverage area of the one or more TRPs 310A–310I. For example, as shown in FIG. 3, an anchor TRP 310D may communicate with the UE 315. The TRP 310D and the UE 315 may be configured for beamformed communications, where the TRP 310D may transmit in the direction of the UE 315 using a directional TRP transmit beam, and the UE 315 may receive the transmission using a directional UE receive beam. Each TRP transmit beam may have an associated beam ID, beam direction, or beam symbols, among other examples. The TRP 310D may transmit downlink communications via one or more TRP transmit beams 320.

The UE 315 may attempt to receive downlink transmissions via one or more UE receive beams 325, which may be configured using different beamforming parameters at receive circuitry of the UE 315. The UE 315 may identify a particular TRP transmit beam 320, shown as TRP transmit beam 320A, and a particular UE receive beam 325, shown as UE receive beam 325A, that provide relatively favorable performance (for example, that have a best channel quality of the different measured combinations of TRP transmit beams 320 and UE receive beams 325). In some examples, the UE 315 may transmit an indication of which TRP transmit beam 320 is identified by the UE 315 as a preferred TRP transmit beam, which the TRP 310D may select for transmissions to the UE 315. The UE 315 may thus attain and maintain a beam pair link (BPL) with the TRP 310D for downlink communications (for example, a combination of the TRP transmit beam 320A and the UE receive beam 325A), which may be further refined and maintained in accordance with one or more established beam refinement procedures.

A downlink beam, such as a TRP transmit beam 320 or a UE receive beam 325, may be associated with a TCI state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each TRP transmit beam 320 may be associated with a synchronization signal block (SSB), and the UE 315 may indicate a preferred TRP transmit beam 320 by transmitting uplink transmissions in resources of the SSB that are associated with the preferred TRP transmit beam 320. A particular SSB may have an associated TCI state (for example, for an antenna port or for beamforming). The TRP 310D may, in some examples, indicate a downlink TRP transmit beam 320 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 325 at the UE 315. Thus, the UE 315 may select a corresponding UE receive beam 325 from a set of BPLs based at least in part on the TRP 310D indicating a TRP transmit beam 320 via a TCI indication.

The TRP 310D may maintain a set of activated TCI states for downlink shared channel transmissions and a set of activated TCI states for downlink control channel transmissions. The set of activated TCI states for downlink shared channel transmissions may correspond to beams that the TRP 310D uses for downlink transmission on a physical downlink shared channel (PDSCH). The set of activated TCI states for downlink control channel communications may correspond to beams that the TRP 310D may use for downlink transmission on a physical downlink control channel (PDCCH) or in a control resource set (CORESET). The UE 315 may also maintain a set of activated TCI states for receiving the downlink shared channel transmissions and the CORESET transmissions. If a TCI state is activated for the UE 315, then the UE 315 may have one or more antenna configurations based at least in part on the TCI state, and the UE 315 may not need to reconfigure antennas or antenna weighting configurations. In some examples, the set of activated TCI states (for example, activated PDSCH TCI states and activated CORESET TCI states) for the UE 315 may be configured by a configuration message, such as a radio resource control (RRC) message.

As indicated above, the cell 305 may be provided using a scalable system. For example, the system may include a distributed massive multiple input multiple output (D-MMIMO) system (which may be referred to, alternatively, as a massively distributed MIMO (MD-MIMO) system). In a D-MMIMO system, a number of TRPs within a cell may be able to serve a UE. Cells in D-MMIMO systems may be very large and may be, for example, associated with a central unit (CU) of an IAB network. In some cases, coordination across cells may be supported so that a UE can travel between cells without disruptive breaks in service. In some cases, D-MMIMO systems can be used to obtain benefits of distributed MIMO as well as massive MIMO (e.g., uniform throughput). In this way, a D-MMIMO system can enable mobility over a large area, while facilitating UE and network power savings.

In many cell systems, however, synchronization of downlink signals often is based on the SSB associated with the cell. For example, as explained above, a TCI state can indicate a QCL property, and that TCI state can be associated with an SSB. In some cases, the SSB is a cell-defining SSB used for initial access and inactive synchronization modes, as well as for connected mode synchronization. For example, in some cases, every downlink and/or uplink QCL relationship can be rooted directly or indirectly to the cell-defining SSB. Additionally, each TRP must transmit at least one SSB, which can be necessary for all RRC states (idle, inactive, and connected). As the number of TRPs within a cell increases, the number of SSBs that can be assigned to the TRPs may not be sufficient. Although SSBs can be reused for more than one TRP, such reuse of SSBs within the cell may cause confusion, particularly where each TRP has a relatively small coverage area (e.g., in cases in which higher bands are employed, such as for MIMO). Thus, implementation of a D-MMIMO cell system can result in negative impacts on network performance.

Some aspects of the techniques and apparatuses described herein provide for a connected mode synchronization in a scalable cell system. For example, in some aspects, a cell may include a plurality of TRPs. The plurality of TRPs may include a set of anchor TRPs and a set of on-demand TRPs, either of which may be selectively activated or deactivated according to traffic in the cell. Idle and inactive mode operations may be decoupled from connected mode operations at the physical layer so that an idle mode SSB may be used as a QCL source for idle and inactive mode operations (e.g., initial access) and a separate, connected mode (CM)-SSB may be used for connected mode operations. For UEs in connected mode, all of the TRPs (both anchor TRPs and on-demand TRPs) may transmit a CM-SSB and each CM-SSB may be associated with the same TCI (e.g., may indicate the same TCI state). Additionally, all of the TRPs in the cell may transmit their respective CM-SSBs on a same frequency. For example, as shown in FIG. 3, once the UE 315 is in connected mode with respect to the cell 305, the anchor TRP 310D may transmit a first CM-SSB 330 to the UE 315 (e.g., using the beam 320A) and, as the UE 315 moves through the cell 305, an on-demand TRP (e.g., the on-demand TRP 310G) may transmit a second CM-SSB 335 to the UE 315. Both CM-SSBs 330 and 335 may be associated with a same frequency and TCI.

In some aspects, the CM-SSBs may be non-cell-defining SSBs. Thus, some aspects may facilitate separate synchronization schemes for initial access/idle mode operations versus connected mode operations and, as a result, a large number of on-demand TRPs may be activated to serve high traffic loads without impacting idle mode operations. Therefore, some aspects may enable deployment of large numbers of TRPs within a cell while avoiding confusion between SSBs. Additionally, TRPs may be in sleep mode during low traffic load, leaving only a small set of TRPs active for broadcast and, as a result, and may thereby facilitate power savings at the network level while maintaining mobility for UEs in a wide area. UE power savings may also be facilitated due to reducing the occurrences of handovers and/or cell reselection, since the size of a cell may be large.

As indicated above, FIG. 3 is provided as an example. Other examples may differ from what is described with respect to FIG. 3.

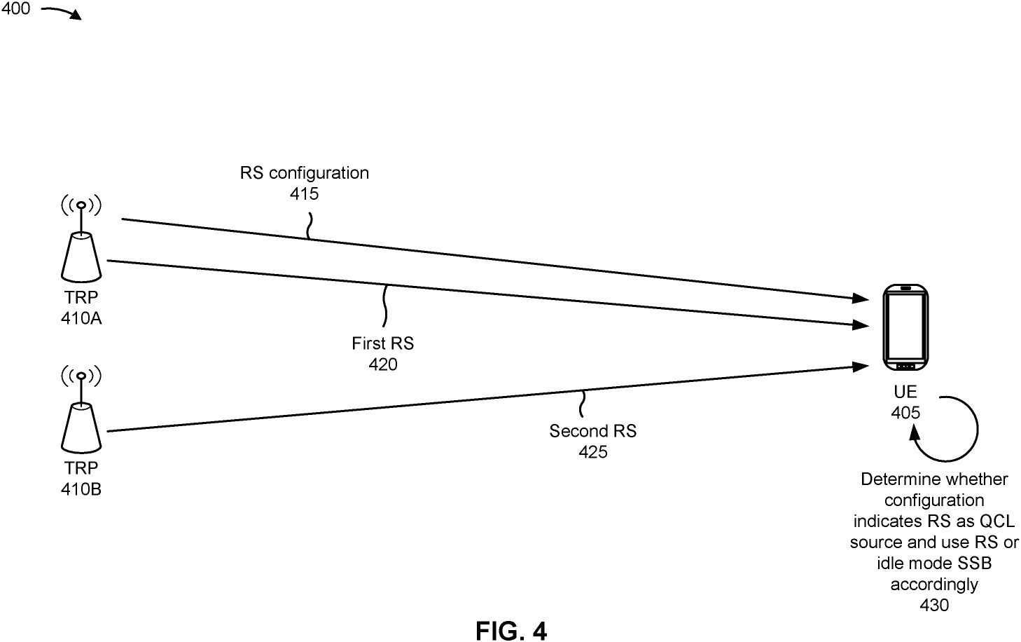

FIG. 4 illustrates an example 400 associated with connected mode synchronization in a scalable cell system, in accordance with the present disclosure. As shown, a UE 405 may communicate with a TRP 410A and a TRP 410B. The TRPs 410A and 410B may be associated with a cell and may be part of a D-MMIMO system, as described above.

In some aspects, the TRP 410A and/or the TRP 410B may include an anchor TRP or an on-demand TRP. Additional TRPs may be associated with the cell. In some aspects, the TRP 410A and/or the TRP 410B may be a distributed unit (DU) of a distributed radio access network (RAN). In some aspects, the TRP 410A and/or the TRP 410B may correspond to a base station 110 described above in connection with FIG. 1. For example, different TRPs 410A and 410B may be included in different base stations 110. In some aspects, multiple TRPs 410A and 410B may be included in a single base station 110. In some aspects, a base station 110 may include a CU (e.g., an access node controller) and/or one or more DUs. In some cases, the TRP 410A and/or the TRP 410B may be referred to as a cell, a panel, an antenna array, or an array. In some cases, the TRP 410A and/or the TRP 410B may include and/or be associated with one or more cells, one or more antenna panels, and/or one or more antenna arrays, among other examples. In some aspects, for example, the TRP 410A may be an antenna panel associated with a base station and the TRP 410B may be a second antenna panel associated with the base station. The TRPs 410A and 410B may be co-located or remotely located with respect to one another. Connections between the TRP 410A, TRP 410B and/or an associated base station may be wired and/or wireless.

In some aspects, the TRP 410A and/or the TRP 410B may transmit communications (e.g., the same communication or different communications) in the same transmission time interval (TTI) (e.g., a slot, a mini-slot, a subframe, or a symbol) or different TTIs using different QCL relationships (e.g., different spatial parameters, different TCI states, different precoding parameters, and/or different beamforming parameters). In some aspects, a TCI state may be used to indicate one or more QCL relationships and, in some aspects, the TRP 410A and the TRP 410B may transmit communications using a same TCI state.

As shown by reference number 415, the TRP 410A may transmit, and the UE 405 may receive, a reference signal (RS) configuration. In some aspects, for example, the RS configuration may include a CM-SSB configuration. The RS configuration may be transmitted using an RRC message. In some aspects, the TRP 410A may be a first on-demand TRP and the TRP 410B may be a second on-demand TRP. The RS configuration may indicate a first frequency channel number associated with a first CM-SSB and a second frequency channel number associated with a second CM-SSB. In some aspects, the RS configuration may indicate a first CM-SSB resource set identifier (ID) corresponding to a first CM-SSB to be transmitted by the TRP 410A and a second CM-SSB resource set ID corresponding to a second CM-SSB to be transmitted by the TRP 410B.

In some aspects, the RS configuration may include a first CM-SSB resource set configuration associated with the first CM-SSB. The first CM-SSB resource set configuration may indicate a first subcarrier spacing (SCS). The RS configuration also may include a second CM-SSB resource set configuration associated with the second CM-SSB. The second CM-SSB resource set configuration may indicate a second SCS. In some aspects, the first CM-SSB resource configuration may indicate a first time-domain window associated with the first CM-SSB and a second time-domain window associated with the second CM-SSB. In some aspects, the second time-domain window is the first time-domain window and, in other aspects, the first and second time-domain windows may be different.

As shown by reference number 420, the TRP 410A may transmit, and the UE 405 may receive, a first RS. In some aspects, the first RS may be a CM-SSB. As shown by reference number 425, the TRP 410B may transmit, and the UE 405 may receive, a second RS. In some aspects, the second RS may be a CM-SSB. The first RS and the second RS may be associated with a same frequency and a same TCI. In some aspects, the first RS and/or the second RS may include a non-cell-defining SSB. A non-cell-defining SSB is a SSB that does not have an associated monitoring configuration for physical downlink control channel (PDCCH) that carries DCI for scheduling physical downlink shared channel (PDSCH) that includes a system information block (SIB 1). For example, a UE may be unable to perform initial access (e.g., random access channel (RACH) procedures) using a non-cell-defining SSB. In some aspects, and in contrast, anchor TRPs may transmit a cell defining SSB that may be used for idle mode operation (e.g., synchronization, initial access, and/or mobility, among other examples).

In some aspects, receiving at least one of the first RS or the second RS may include receiving at least one RS instance of a plurality of RS instances. For example, in some aspects, each RS instance may be an RS repetition of a plurality of RS repetitions. Each RS instance of the plurality of RS instances may be associated with a respective transmit beam of a plurality of transmit beams and/or a respective receive beam of a plurality of receive beams. In this way, some aspects may facilitate sweeping an RS over a number of different directions to support beam sweeping by a receiving UE 405. The plurality of RS instances may be associated with at least one of a periodic time resource allocation, a semi-persistent time resource allocation, or an aperiodic time resource allocation. In some aspects, the first RS and the second RS may be associated with a same SCS or different SCSs.

As shown by reference number 430, the UE 405 may determine whether the RS configuration indicates at least one of the first RS or the second RS as a QCL source (e.g., for a reference signal), and may use the indicated RS as a QCL source. If at least one of the RSs is not indicated as the QCL source, the UE 405 may use an idle mode SSB as the QCL source. For example, in some aspects, the RS configuration may include a TCI state IE that indicates a CM-SSB resource set ID associated with the at least one of the first RS or the second RS.

As indicated above, FIG. 4 is provided as an example. Other examples may differ from what was described with regard to FIG. 4.

FIG. 5 is a diagram illustrating an example process 500 performed, for example, by a UE, in accordance with the present disclosure. Example process 500 is an example where the UE (e.g., UE 405) performs operations associated with connected mode synchronization in a scalable cell system.

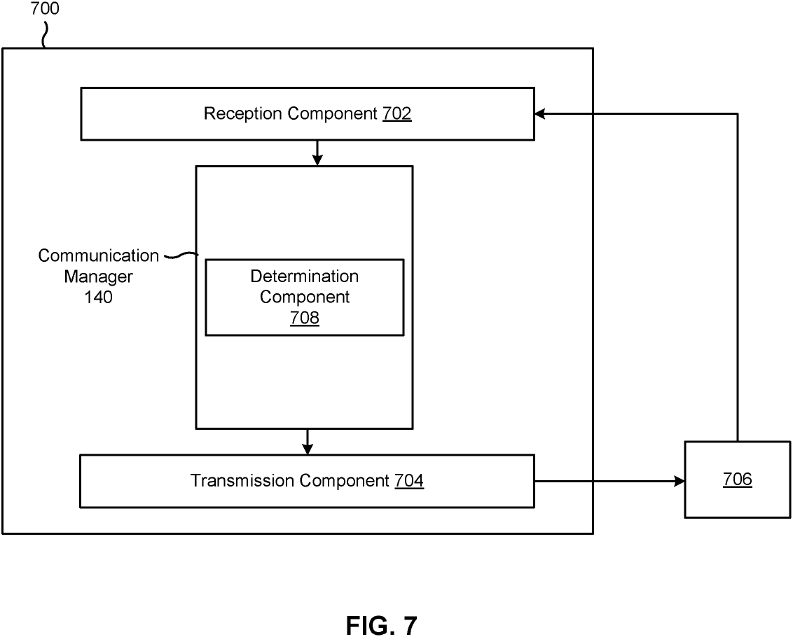

As shown in FIG. 5, in some aspects, process 500 may include receiving a first RS from a first antenna panel of a plurality of antenna panels associated with at least one TRP of a scalable cell system that includes a set of anchor TRPs associated with a cell and a set of on-demand TRPs associated with the cell, wherein the first RS is associated with a frequency and a TCI (block 510). For example, the UE (e.g., using communication manager 140 and/or reception component 702, depicted in FIG. 7) may receive a first RS from a first antenna panel of a plurality of antenna panels associated with at least one TRP of a scalable cell system that includes a set of anchor TRPs associated with a cell and a set of on-demand TRPs associated with the cell, wherein the first RS is associated with a frequency and a TCI, as described above, for example, with reference to FIG. 4.

As further shown in FIG. 5, in some aspects, process 500 may include receiving a second RS from a second antenna panel of the plurality of antenna panels, wherein the second RS is associated with the frequency and the TCI, and wherein the at least one TRP comprises an on-demand TRP (block 520). For example, the UE (e.g., using communication manager 140 and/or reception component 702, depicted in FIG. 7) may receive a second RS from a second antenna panel of the plurality of antenna panels, wherein the second RS is associated with the frequency and the TCI, and wherein the at least one TRP comprises an on-demand TRP, as described above, for example, with reference to FIG. 4.

Process 500 may include additional aspects, such as any single aspect or any combination of aspects described below and/or in connection with one or more other processes described elsewhere herein.

In a first aspect, at least one of the first RS or the second RS comprises an SSB. In a second aspect, alone or in combination with the first aspect, the SSB comprises a CM-SSB. In a third aspect, alone or in combination with the second aspect, the CM-SSB comprises a non-cell-defining SSB.

In a fourth aspect, alone or in combination with one or more of the first through third aspects, receiving at least one of the first RS or the second RS comprises receiving at least one RS instance of a plurality of RS instances. In a fifth aspect, alone or in combination with the fourth aspect, each RS instance of the plurality of RS instances is associated with a respective transmit beam of a plurality of transmit beams. In a sixth aspect, alone or in combination with one or more of the fourth through fifth aspects, receiving the at least one of the first RS or the second RS comprises performing a beam sweeping operation associated with a plurality of receive beams. In a seventh aspect, alone or in combination with one or more of the fourth through sixth aspects, the plurality of RS instances are associated with at least one of a periodic time resource allocation, a semi-persistent time resource allocation, or an aperiodic time resource allocation.

In an eighth aspect, alone or in combination with one or more of the first through seventh aspects, the first antenna panel is associated with a first on-demand TRP and wherein the second antenna panel is associated with a second on-demand TRP, the method further comprising receiving a first CM-SSB resource set ID corresponding to the first on-demand TRP, and receiving a second CM-SSB resource set ID corresponding to the second on-demand TRP. In a ninth aspect, alone or in combination with one or more of the first through eighth aspects, the first antenna panel is associated with a first on-demand TRP and wherein the second antenna panel is associated with a second on-demand TRP, the method further comprising receiving a first frequency channel number associated with the first RS, and receiving a second frequency channel number associated with the second RS.

In a tenth aspect, alone or in combination with one or more of the first through ninth aspects, the first RS is associated with a subcarrier spacing and wherein the second RS is associated with the subcarrier spacing. In an eleventh aspect, alone or in combination with one or more of the first through tenth aspects, the first RS is associated with a first subcarrier spacing and wherein the second RS is associated with a second subcarrier spacing that is different than the first subcarrier spacing. In a twelfth aspect, alone or in combination with the eleventh aspect, process 500 includes receiving a first CM-SSB resource set configuration associated with the first RS, wherein the first CM-SSB resource set configuration indicates the first subcarrier spacing, and receiving a second CM-SSB resource set configuration associated with the second RS, wherein the second CM-SSB resource set configuration indicates the second subcarrier spacing.

In a thirteenth aspect, alone or in combination with one or more of the first through twelfth aspects, process 500 includes receiving a first CM-SSB resource set configuration associated with the first RS, wherein the first CM-SSB resource set configuration indicates a first time-domain window associated with the first RS, and receiving a second CM-SSB resource set configuration associated with the second RS, wherein the second CM-SSB resource set configuration indicates a second time-domain window associated with the second RS. In a fourteenth aspect, alone or in combination with the thirteenth aspect, the second time-domain window is the first time-domain window.

In a fifteenth aspect, alone or in combination with one or more of the first through fourteenth aspects, at least one of the first RS or the second RS comprises a QCL source for at least one reference signal. In a sixteenth aspect, alone or in combination with the fifteenth aspect, process 500 includes receiving a configuration that includes a TCI state IE, wherein the TCI state IE indicates a CM-SSB resource set ID associated with the at least one of the first RS or the second RS. In a seventeenth aspect, alone or in combination with one or more of the first through sixteenth aspects, process 500 includes receiving a configuration associated with at least one of the first RS or the second RS, determining that the configuration does not indicate that at least one of the first RS or the second RS comprises a QCL source for at least one reference signal (e.g., at least one channel state information-RS (CSI-RS) and/or at least one demodulation RS (DMRS), among other examples), and using, based at least in part on the determination that the configuration does not indicate that at least one of the first RS or the second RS comprises a QCL source for the at least one reference signal, an idle mode SSB of an anchor TRP of the set of anchor TRPs as the QCL source for the at least one reference signal. As such, an idle mode SSB of an anchor TRP of the set of anchor TRPs can serve as a default QCL source for the at least one reference signal when the configuration does not provide an indication that the first RS and/or second RS are to serve as a QCL source for the at least one reference signal.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a first TRP, in accordance with the present disclosure. Example process 600 is an example where the TRP (e.g., TRP 410A) performs operations associated with connected mode synchronization in a scalable cell system.

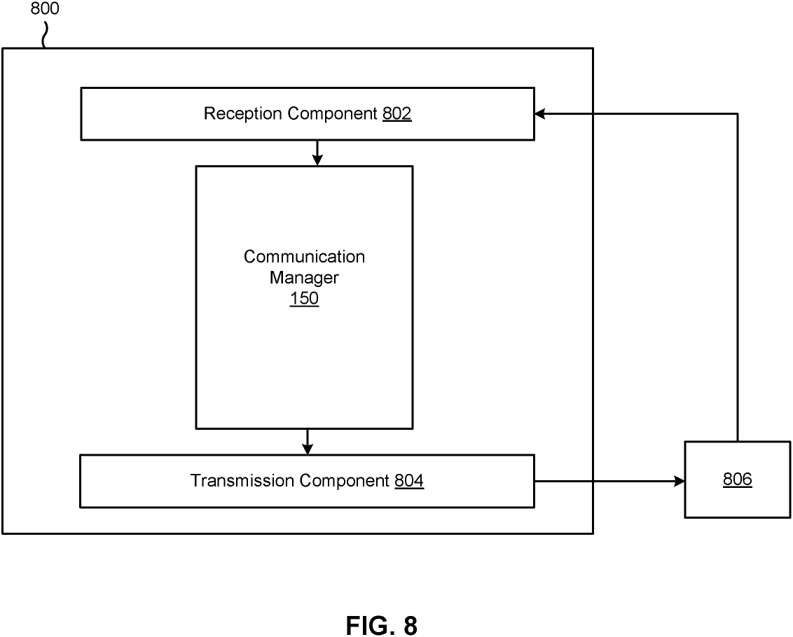

As shown in FIG. 6, in some aspects, process 600 may include transmitting an RS configuration that indicates a first RS corresponding to a first antenna panel associated with the first TRP and associated with a frequency and a TCI, wherein the frequency and the TCI are associated with a second RS corresponding to a second antenna panel associated with the first TRP or a second TRP of the plurality of TRPs (block 610). For example, the TRP (e.g., using communication manager 150 and/or transmission component 804, depicted in FIG. 8) may transmit an RS configuration that indicates a first RS corresponding to a first antenna panel associated with the first TRP and associated with a frequency and a TCI, wherein the frequency and the TCI are associated with a second RS corresponding to a second antenna panel associated with the first TRP or a second TRP of the plurality of TRPs, as described above, for example, with reference to FIG. 4.

As further shown in FIG. 6, in some aspects, process 600 may include transmitting the first RS, wherein at least one of the first TRP or the second TRP comprises an on-demand TRP (block 620). For example, the TRP (e.g., using communication manager 150 and/or transmission component 804, depicted in FIG. 8) may transmit the first RS, wherein at least one of the first TRP or the second TRP comprises an on-demand TRP, as described above, for example, with reference to FIG. 4.

Process 600 may include additional aspects, such as any single aspect or any combination of aspects described below and/or in connection with one or more other processes described elsewhere herein.

In a first aspect, at least one of the first RS or the second RS comprises an SSB. In a second aspect, alone or in combination with the first aspect, the SSB comprises a CM-SSB. In a third aspect, alone or in combination with the second aspect, the CM-SSB comprises a non-cell-defining SSB.

In a fourth aspect, alone or in combination with one or more of the first through third aspects, transmitting the first RS comprises transmitting at least one RS instance of a plurality of RS instances. In a fifth aspect, alone or in combination with the fourth aspect, transmitting the at least one RS instance comprises transmitting each RS instance of the plurality of RS instances using a respective transmit beam of a plurality of transmit beams. In a sixth aspect, alone or in combination with one or more of the fourth through fifth aspects, the plurality of RS instances are associated with at least one of a periodic time resource allocation, a semi-persistent time resource allocation, or an aperiodic time resource allocation.

In a seventh aspect, alone or in combination with one or more of the first through sixth aspects, the first TRP comprises a first on-demand TRP and the second TRP comprises a second on-demand TRP, the method further comprising transmitting a first CM-SSB resource set ID corresponding to the first RS, wherein a second CM-SSB resource set ID corresponds to the second RS. In an eighth aspect, alone or in combination with one or more of the first through seventh aspects, process 600 includes transmitting a first frequency channel number associated with the first RS, wherein a second frequency channel number is associated with the second RS.

In a ninth aspect, alone or in combination with one or more of the first through eighth aspects, the first RS is associated with a first subcarrier spacing and wherein the second RS is associated with a second subcarrier spacing. In a tenth aspect, alone or in combination with one or more of the first through ninth aspects, process 600 includes transmitting a first CM-SSB resource set configuration associated with the first RS, wherein the first CM-SSB resource set configuration indicates a first time-domain window associated with the first RS, and wherein a second CM-SSB resource set configuration associated with the second RS indicates a second time-domain window associated with the second RS.

In an eleventh aspect, alone or in combination with one or more of the first through tenth aspects, at least one of the first RS or the second RS comprises a QCL source for at least one reference signal. In a twelfth aspect, alone or in combination with the eleventh aspect, process 600 includes transmitting a configuration that includes a TCI state IE, wherein the TCI state IE indicates a CM-SSB resource set ID associated with the first RS. In a thirteenth aspect, alone or in combination with one or more of the first through twelfth aspects, process 600 includes transmitting a configuration associated with the first RS that does not indicate that the first RS comprises a QCL source for at least one additional RS, wherein an idle mode SSB of an anchor TRP of the set of anchor TRPs comprises the QCL source for the at least one additional RS.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include a determination component 708.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The reception component 702 may receive a first RS from a first antenna panel of a plurality of antenna panels associated with at least one TRP of a scalable cell system that includes a set of anchor TRPs associated with a cell and a set of on-demand TRPs associated with the cell, wherein the first RS is associated with a frequency and a TCI. The reception component 702 may receive a second RS from a second antenna panel of the plurality of antenna panels, wherein the second RS is associated with the frequency and the TCI, and wherein the at least one TRP comprises an on-demand TRP.

The reception component 702 may receive a first CM-SSB resource set configuration associated with the first RS, wherein the first CM-SSB resource set configuration indicates the first subcarrier spacing. The reception component 702 may receive a second CM-SSB resource set configuration associated with the second RS, wherein the second CM-SSB resource set configuration indicates the second subcarrier spacing. The reception component 702 may receive a first CM-SSB resource set configuration associated with the first RS, wherein the first CM-SSB resource set configuration indicates a first time-domain window associated with the first RS. The reception component 702 may receive a second CM-SSB resource set configuration associated with the second RS, wherein the second CM-SSB resource set configuration indicates a second time-domain window associated with the second RS. The reception component 702 may receive a configuration that includes a TCI state IE, wherein the TCI state IE indicates a CM-SSB resource set ID associated with the at least one of the first RS or the second RS.

The reception component 702 may receive a configuration associated with at least one of the first RS or the second RS. The determination component 708 may determine that the configuration does not indicate that at least one of the first RS or the second RS comprises a QCL source for at least one reference signal. In some aspects, the determination component 708 may include one or more antennas, a modem, a modulator, a transmit MIMO processor, a transmit processor, a controller/processor, a memory, or a combination thereof, of the UE described in connection with FIG. 2. In some aspects, the determination component 708 may include the reception component 702 and/or the transmission component 704.

The communication manager 140 may use, based at least in part on the determination that the configuration does not indicate that at least one of the first RS or the second RS comprises a QCL source for the at least one reference signal, an idle mode SSB of an anchor TRP of the set of anchor TRPs as the QCL source for the at least one reference signal. In some aspects, the communication manager 140 may include one or more antennas, a modem, a modulator, a transmit MIMO processor, a transmit processor, a controller/processor, a memory, or a combination thereof, of the UE described in connection with FIG. 2. In some aspects, the communication manager 140 may include the reception component 702 and/or the transmission component 704.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a TRP, or a TRP may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 150.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the base station described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the base station described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the base station described in connection with FIG. 2. In some aspects, the transmission component 804 may be co-located with the reception component 802 in a transceiver.

The transmission component 804 may transmit an RS configuration that indicates a first RS corresponding to a first antenna panel associated with the first TRP and associated with a frequency and a TCI, wherein the frequency and the TCI are associated with a second RS corresponding to a second antenna panel associated with the first TRP or a second TRP of the plurality of TRPs. The transmission component 804 may transmit the first RS, wherein at least one of the first TRP or the second TRP comprises an on-demand TRP. The transmission component 804 may transmit a first frequency channel number associated with the first RS, wherein a second frequency channel number is associated with the second RS. The transmission component 804 may transmit a first CM-SSB resource set configuration associated with the first RS, wherein the first CM-SSB resource set configuration indicates a first time-domain window associated with the first RS, and wherein a second CM-SSB resource set configuration associated with the second RS indicates a second time-domain window associated with the second RS.

The communication manager 150 may generate, and the transmission component 804 may transmit, a configuration that includes a TCI state IE, wherein the TCI state IE indicates a CM-SSB resource set ID associated with the first RS. In some aspects, the communication manager 150 may include one or more antennas, a modem, a modulator, a transmit MIMO processor, a transmit processor, a controller/processor, a memory, or a combination thereof, of the base station described in connection with FIG. 2. In some aspects, the communication manager 150 may include the reception component 802 and/or the transmission component 804.

The transmission component 804 may transmit a configuration associated with the first RS that does not indicate that the first RS comprises a QCL source for at least one additional RS, wherein an idle mode SSB of an anchor TRP of the set of anchor TRPs comprises the QCL source for the at least one additional RS.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving a first reference signal (RS) from a first antenna panel of a plurality of antenna panels associated with at least one transmit receive point (TRP) of a scalable cell system that includes a set of anchor TRPs associated with a cell and a set of on-demand TRPs associated with the cell, wherein the first RS is associated with a frequency and a transmission configuration indicator (TCI); and receiving a second RS from a second antenna panel of the plurality of antenna panels, wherein the second RS is associated with the frequency and the TCI, and wherein the at least one TRP comprises an on-demand TRP.

Aspect 2: The method of Aspect 1, wherein at least one of the first RS or the second RS comprises a synchronization signal block (SSB).

Aspect 3: The method of Aspect 2, wherein the SSB comprises a connected mode (CM)-SSB (CM-SSB).

Aspect 4: The method of Aspect 3, wherein the CM-SSB comprises a non-cell-defining SSB.

Aspect 5: The method of any of Aspects 1-4, wherein receiving at least one of the first RS or the second RS comprises receiving at least one RS instance of a plurality of RS instances.

Aspect 6: The method of Aspect 5, wherein each RS instance of the plurality of RS instances is associated with a respective transmit beam of a plurality of transmit beams.

Aspect 7: The method of either of Aspects 5 or 6, wherein receiving the at least one of the first RS or the second RS comprises performing a beam sweeping operation associated with a plurality of receive beams.

Aspect 8: The method of any of Aspects 5-7, wherein the plurality of RS instances are associated with at least one of a periodic time resource allocation, a semi-persistent time resource allocation, or an aperiodic time resource allocation.

Aspect 9: The method of any of Aspects 1-8, wherein the first antenna panel is associated with a first on-demand TRP and wherein the second antenna panel is associated with a second on-demand TRP, the method further comprising: receiving a first connected mode (CM)-SSB (CM-SSB) resource set identifier (ID) corresponding to the first on-demand TRP; and receiving a second CM-SSB resource set ID corresponding to the second on-demand TRP.

Aspect 10: The method of any of Aspects 1-9, wherein the first antenna panel is associated with a first on-demand TRP and wherein the second antenna panel is associated with a second on-demand TRP, the method further comprising: receiving a first frequency channel number associated with the first RS; and receiving a second frequency channel number associated with the second RS.

Aspect 11: The method of any of Aspects 1-10, wherein the first RS is associated with a subcarrier spacing and wherein the second RS is associated with the subcarrier spacing.

Aspect 12: The method of any of Aspects 1-11, wherein the first RS is associated with a first subcarrier spacing and wherein the second RS is associated with a second subcarrier spacing that is different than the first subcarrier spacing.

Aspect 13: The method of Aspect 12, further comprising: receiving a first connected mode (CM)-SSB (CM-SSB) resource set configuration associated with the first RS, wherein the first CM-SSB resource set configuration indicates the first subcarrier spacing; and receiving a second CM-SSB resource set configuration associated with the second RS, wherein the second CM-SSB resource set configuration indicates the second subcarrier spacing.

Aspect 14: The method of any of Aspects 1-13, further comprising: receiving a first connected mode (CM)-SSB (CM-SSB) resource set configuration associated with the first RS, wherein the first CM-SSB resource set configuration indicates a first time-domain window associated with the first RS; and receiving a second CM-SSB resource set configuration associated with the second RS, wherein the second CM-SSB resource set configuration indicates a second time-domain window associated with the second RS.

Aspect 15: The method of Aspect 14, wherein the second time-domain window is the first time-domain window.

Aspect 16: The method of any of Aspects 1-15, wherein at least one of the first RS or the second RS comprises a quasi co-location (QCL) source for at least one reference signal.

Aspect 17: The method of Aspect 16, further comprising receiving a configuration that includes a TCI state information element (IE), wherein the TCI state IE indicates a CM-SSB resource set identifier (ID) associated with the at least one of the first RS or the second RS.

Aspect 18: The method of any of Aspects 1-17, further comprising: receiving a configuration associated with at least one of the first RS or the second RS; determining that the configuration does not indicate that at least one of the first RS or the second RS comprises a quasi co-location (QCL) source for at least one reference signal; and using, based at least in part on the determination that the configuration does not indicate that at least one of the first RS or the second RS comprises a QCL source for the at least one reference signal, an idle mode synchronization signal block (SSB) of an anchor TRP of the set of anchor TRPs as the QCL source for the at least one reference signal.

Aspect 19: A method of wireless communication performed by a first transmission reception point (TRP) of a plurality of TRPs of a scalable cell system that includes a set of anchor TRPs associated with a cell and a set of on-demand TRPs associated with the cell, comprising: transmitting a reference signal (RS) configuration that indicates a first RS corresponding to a first antenna panel associated with the first TRP and associated with a frequency and a transmission configuration indicator (TCI), wherein the frequency and the TCI are associated with a second RS corresponding to a second antenna panel associated with the first TRP or a second TRP of the plurality of TRPs; and transmitting the first RS, wherein at least one of the first TRP or the second TRP comprises an on-demand TRP.

Aspect 20: The method of Aspect 19, wherein at least one of the first RS or the second RS comprises a synchronization signal block (SSB).

Aspect 21: The method of Aspect 20, wherein the SSB comprises a connected mode (CM)-SSB (CM-SSB).

Aspect 22: The method of Aspect 21, wherein the CM-SSB comprises a non-cell-defining SSB.

Aspect 23: The method of any of Aspects 19-22, wherein transmitting the first RS comprises transmitting at least one RS instance of a plurality of RS instances.

Aspect 24: The method of Aspect 23, wherein transmitting the at least one RS instance comprises transmitting each RS instance of the plurality of RS instances using a respective transmit beam of a plurality of transmit beams.

Aspect 25: The method of either of Aspects 23 or 24, wherein the plurality of RS instances are associated with at least one of a periodic time resource allocation, a semi-persistent time resource allocation, or an aperiodic time resource allocation.

Aspect 26: The method of any of Aspects 19-25, wherein the first TRP comprises a first on-demand TRP and the second TRP comprises a second on-demand TRP, the method further comprising transmitting a first connected mode (CM)-SSB (CM-SSB) resource set identifier (ID) corresponding to the first RS, wherein a second CM-SSB resource set ID corresponds to the second RS.

Aspect 27: The method of any of Aspects 19-26, further comprising transmitting a first frequency channel number associated with the first RS, wherein a second frequency channel number is associated with the second RS.

Aspect 28: The method of any of Aspects 19-27, wherein the first RS is associated with a first subcarrier spacing and wherein the second RS is associated with a second subcarrier spacing.

Aspect 29: The method of any of Aspects 19-28, further comprising transmitting a first connected mode (CM)-SSB (CM-SSB) resource set configuration associated with the first RS, wherein the first CM-SSB resource set configuration indicates a first time-domain window associated with the first RS, and wherein a second CM-SSB resource set configuration associated with the second RS indicates a second time-domain window associated with the second RS.

Aspect 30: The method of any of Aspects 19-29, wherein at least one of the first RS or the second RS comprises a quasi co-location (QCL) source for at least one reference signal.

Aspect 31: The method of Aspect 30, further comprising transmitting a configuration that includes a TCI state information element (IE), wherein the TCI state IE indicates a CM-SSB resource set identifier (ID) associated with the first RS.

Aspect 32: The method of any of Aspects 19-31, further comprising transmitting a configuration associated with the first RS that does not indicate that the first RS comprises a quasi co-location (QCL) source for at least one additional RS, wherein an idle mode synchronization signal block (SSB) of an anchor TRP of the set of anchor TRPs comprises the QCL source for the at least one additional RS.

Aspect 33: An apparatus for wireless communication at a device, comprising a processor; memory coupled with the processor; and instructions stored in the memory and executable by the processor to cause the apparatus to perform the method of one or more of Aspects 1-18.

Aspect 34: A device for wireless communication, comprising a memory and one or more processors coupled to the memory, the one or more processors configured to perform the method of one or more of Aspects 1-18.

Aspect 35: An apparatus for wireless communication, comprising at least one means for performing the method of one or more of Aspects 1-18.

Aspect 36: A non-transitory computer-readable medium storing code for wireless communication, the code comprising instructions executable by a processor to perform the method of one or more of Aspects 1-18.

Aspect 37: A non-transitory computer-readable medium storing a set of instructions for wireless communication, the set of instructions comprising one or more instructions that, when executed by one or more processors of a device, cause the device to perform the method of one or more of Aspects 1-18.

Aspect 38: An apparatus for wireless communication at a device, comprising a processor; memory coupled with the processor; and instructions stored in the memory and executable by the processor to cause the apparatus to perform the method of one or more of Aspects 19-32.

Aspect 39: A device for wireless communication, comprising a memory and one or more processors coupled to the memory, the one or more processors configured to perform the method of one or more of Aspects 19-32.

Aspect 40: An apparatus for wireless communication, comprising at least one means for performing the method of one or more of Aspects 19-32.

Aspect 41: A non-transitory computer-readable medium storing code for wireless communication, the code comprising instructions executable by a processor to perform the method of one or more of Aspects 19-32.

Aspect 42: A non-transitory computer-readable medium storing a set of instructions for wireless communication, the set of instructions comprising one or more instructions that, when executed by one or more processors of a device, cause the device to perform the method of one or more of Aspects 19-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving a first reference signal (RS) from a first antenna panel of a plurality of antenna panels associated with at least one transmit receive point (TRP) of a scalable cell system that includes a set of anchor TRPs associated with a cell and a set of on-demand TRPs associated with the cell, wherein the first RS is associated with a frequency and a transmission configuration indicator (TCI); and
receiving a second RS from a second antenna panel of the plurality of antenna panels, wherein the second RS is associated with the frequency and the TCI.

2. The method of claim 1, wherein the at least one TRP comprises an on-demand TRP, and wherein at least one of the first RS or the second RS comprises a synchronization signal block (SSB).

3. The method of claim 2, wherein the SSB comprises a connected mode (CM)-SSB (CM-SSB).

4. The method of claim 3, wherein the CM-SSB comprises a non-cell-defining SSB.

5. The method of claim 1, wherein receiving at least one of the first RS or the second RS comprises performing a beam sweeping operation associated with a plurality of receive beams to receive at least one RS instance of a plurality of RS instances, wherein each RS instance of the plurality of RS instances is associated with a respective transmit beam of a plurality of transmit beams, and wherein the plurality of RS instances are associated with at least one of a periodic time resource allocation, a semi-persistent time resource allocation, or an aperiodic time resource allocation.

6. The method of claim 1, wherein the at least one TRP comprises a first on-demand TRP and a second on-demand TRP and wherein the first antenna panel is associated with the first on-demand TRP and wherein the second antenna panel is associated with the second on-demand TRP, the method further comprising:
receiving a first connected mode (CM)-SSB (CM-SSB) resource set identifier (ID) corresponding to the first on-demand TRP; and
receiving a second CM-SSB resource set ID corresponding to the second on-demand TRP.

7. The method of claim 1, wherein the at least one TRP comprises a first on-demand TRP and a second on-demand TRP and wherein the first antenna panel is associated with the first on-demand TRP and wherein the second antenna panel is associated with the second on-demand TRP, the method further comprising:
receiving a first frequency channel number associated with the first RS; and
receiving a second frequency channel number associated with the second RS.

8. The method of claim 1, wherein the first RS is associated with a subcarrier spacing and wherein the second RS is associated with the subcarrier spacing.

9. The method of claim 1, wherein the first RS is associated with a first subcarrier spacing and wherein the second RS is associated with a second subcarrier spacing that is different than the first subcarrier spacing, the method further comprising:
receiving a first connected mode (CM)-SSB (CM-SSB) resource set configuration associated with the first RS, wherein the first CM-SSB resource set configuration indicates the first subcarrier spacing; and
receiving a second CM-SSB resource set configuration associated with the second RS, wherein the second CM-SSB resource set configuration indicates the second subcarrier spacing.

10. The method of claim 1, further comprising:
receiving a first connected mode (CM)-SSB (CM-SSB) resource set configuration associated with the first RS, wherein the first CM-SSB resource set configuration indicates a first time-domain window associated with the first RS; and
receiving a second CM-SSB resource set configuration associated with the second RS, wherein the second CM-SSB resource set configuration indicates a second time-domain window associated with the second RS.

11. The method of claim 10, wherein the second time-domain window is the first time-domain window.

12. The method of claim 1, wherein at least one of the first RS or the second RS comprises a quasi co-location (QCL) source for at least one additional reference signal, the method further comprising receiving a configuration that includes a TCI state information element (IE), wherein the TCI state IE indicates a connected mode (CM)-SSB (CM-SSB) resource set identifier (ID) associated with the at least one of the first RS or the second RS.

13. The method of claim 1, further comprising:
receiving a configuration associated with at least one of the first RS or the second RS;
determining that the configuration does not indicate that at least one of the first RS or the second RS comprises a quasi co-location (QCL) source for at least one additional reference signal; and
using, based at least in part on the determination that the configuration does not indicate that at least one of the first RS or the second RS comprises a QCL source for the at least one additional reference signal, an idle mode synchronization signal block (SSB) of an anchor TRP of the set of anchor TRPs as the QCL source for the at least one additional reference signal.

14. A method of wireless communication performed by a first transmission reception point (TRP) of a plurality of TRPs of a scalable cell system that includes a set of anchor TRPs associated with a cell and a set of on-demand TRPs associated with the cell, comprising:
transmitting a reference signal (RS) configuration that indicates a first RS corresponding to a first antenna panel associated with the first TRP and associated with a frequency and a transmission configuration indicator (TCI), wherein the frequency and the TCI are associated with a second RS corresponding to a second antenna panel associated with the first TRP or a second TRP of the plurality of TRPs; and
transmitting the first RS, wherein at least one of the first TRP or the second TRP comprises an on-demand TRP.

15. The method of claim 14, wherein at least one of the first RS or the second RS comprises a connected mode (CM)-synchronization signal block (SSB) (CM-SSB), and wherein the CM-SSB comprises a non-cell-defining SSB.

16. The method of claim 14, wherein transmitting the first RS comprises transmitting at least one RS instance of a plurality of RS instances, wherein transmitting the at least one RS instance comprises transmitting each RS instance of the plurality of RS instances using a respective transmit beam of a plurality of transmit beams.

17. The method of claim 14, wherein the first TRP comprises a first on-demand TRP and the second TRP comprises a second on-demand TRP, the method further comprising transmitting a first connected mode (CM)-SSB (CM-SSB) resource set identifier (ID) corresponding to the first RS, wherein a second CM-SSB resource set ID corresponds to the second RS.

18. The method of claim 14, further comprising transmitting a first frequency channel number associated with the first RS, wherein a second frequency channel number is associated with the second RS.

19. The method of claim 14, further comprising transmitting a first connected mode (CM)-SSB (CM-SSB) resource set configuration associated with the first RS, wherein the first CM-SSB resource set configuration indicates a first time-domain window associated with the first RS, and wherein a second CM-SSB resource set configuration associated with the second RS indicates a second time-domain window associated with the second RS.

20. A user equipment (UE) for wireless communication, comprising:
a memory;
a transceiver; and
one or more processors, coupled to the memory and the transceiver, configured to:
receive, via the transceiver, a first reference signal (RS) from a first antenna panel of a plurality of antenna panels associated with at least one transmit receive point (TRP) of a scalable cell system that includes a set of anchor TRPs associated with a cell and a set of on-demand TRPs associated with the cell, wherein the first RS is associated with a frequency and a transmission configuration indicator (TCI); and
receive, via the transceiver, a second RS from a second antenna panel of the plurality of antenna panels, wherein the second RS is associated with the frequency and the TCI, and wherein the at least one TRP comprises an on-demand TRP.

21. The UE of claim 20, wherein at least one of the first RS or the second RS comprises a connected mode (CM)-synchronization signal block (SSB) (CM-SSB), wherein the CM-SSB is a non-cell defining SSB.

22. The UE of claim 20, wherein the one or more processors, to receive at least one of the first RS or the second RS, are configured to perform a beam sweeping operation associated with a plurality of receive beams to receive at least one RS instance of a plurality of RS instances, wherein each RS instance of the plurality of RS instances is associated with a respective transmit beam of a plurality of transmit beams, and wherein the plurality of RS instances are associated with at least one of a periodic time resource allocation, a semi-persistent time resource allocation, or an aperiodic time resource allocation.

23. The UE of claim 20, wherein the at least one TRP comprises a first on-demand TRP and a second on-demand TRP and wherein the first antenna panel is associated with the first on-demand TRP and wherein the second antenna panel is associated with the second on-demand TRP, wherein the one or more processors are further configured to:
receive, via the transceiver, at least one of a first connected mode (CM)-SSB (CM-SSB) resource set identifier (ID) corresponding to the first on-demand TRP or a first frequency channel number associated with the first RS; and
receive, via the transceiver, at least one of a second CM-SSB resource set ID corresponding to the second on-demand TRP or a second frequency channel number associated with the second RS.

24. The UE of claim 20, wherein the first RS is associated with a first subcarrier spacing, wherein the second RS is associated with a second subcarrier spacing that is different than the first subcarrier spacing, and wherein the one or more processors are further configured to:
receive, via the transceiver, a first connected mode (CM)-SSB (CM-SSB) resource set configuration associated with the first RS, wherein the first CM-SSB resource set configuration indicates the first subcarrier spacing; and
receive, via the transceiver, a second CM-SSB resource set configuration associated with the second RS, wherein the second CM-SSB resource set configuration indicates the second subcarrier spacing.

25. The UE of claim 20, wherein the one or more processors are further configured to:
receive, via the transceiver, a first connected mode (CM)- SSB (CM-SSB) resource set configuration associated with the first RS, wherein the first CM-SSB resource set configuration indicates a first time-domain window associated with the first RS; and
receive, via the transceiver, a second CM-SSB resource set configuration associated with the second RS, wherein the second CM-SSB resource set configuration indicates a second time-domain window associated with the second RS.

26. The UE of claim 20, wherein at least one of the first RS or the second RS comprises a quasi co-location (QCL) source for at least one additional reference signal, and wherein the one or more processors are further configured to receive, via the transceiver, a configuration that includes a TCI state information element (IE), wherein the TCI state IE indicates a connected mode (CM)-SSB (CM-SSB) resource set identifier (ID) associated with the at least one of the first RS or the second RS.

27. A first transmission reception point (TRP) for wireless communication, comprising:
a memory; and
one or more processors, coupled to the memory, configured to:
transmit a reference signal (RS) configuration that indicates a first RS corresponding to a first antenna panel associated with the first TRP and associated with a frequency and a transmission configuration indicator (TCI), wherein the frequency and the TCI are associated with a second RS corresponding to a second antenna panel associated with the first TRP or a second TRP of the plurality of TRPs; and
transmit the first RS, wherein at least one of the first TRP or the second TRP comprises an on-demand TRP.

28. The first TRP of claim 27, wherein at least one of the first RS or the second RS comprises a connected mode (CM)-synchronization signal block (SSB) (CM-SSB) and wherein the CM-SSB comprises a non-cell-defining SSB.

29. The first TRP of claim 27, wherein the first TRP comprises a first on-demand TRP and the second TRP comprises a second on-demand TRP, the method further comprising transmitting a first connected mode (CM)- SSB (CM-SSB) resource set identifier (ID) corresponding to the first RS, wherein a second CM-SSB resource set ID corresponds to the second RS.

30. The first TRP of claim 27, wherein the one or more processors are further configured to transmit a first connected mode (CM)- SSB (CM-SSB) resource set configuration associated with the first RS, wherein the first CM-SSB resource set configuration indicates a first time-domain window associated with the first RS, and wherein a second CM-SSB resource set configuration associated with the second RS indicates a second time-domain window associated with the second RS.
